(19) United States
(12) Patent Application Publication
(10) Pub. No.: US 2018/0022158 A1
(43) Pub. Date: Jan. 25, 2018

(54) RADIAL TIRE HAVING AN IMPROVED BELT STRUCTURE

(71) Applicant: COMPAGNIE GENERALE DES ETABLISSEMENTS MICHELIN, CLERMONT-FERRAND (FR)

(72) Inventors: AURORE LARDJANE, Clermont-Ferrand (FR); CAMILLE ASTAIX, Clermont-Ferrand (FR)

(73) Assignee: COMPAGNIE GENERALE DES ETABLISSEMENTS MICHELIN, CLERMONT-FERRAND (FR)

(21) Appl. No.: 15/547,979

(22) PCT Filed: Jan. 22, 2016
(86) PCT No.: PCT/EP2016/051304

§ 371 Date: Aug. 1, 2017

(30) Foreign Application Priority Data
Feb. 3, 2015 (FR) 1550813

(51) Int. Cl. B60C 9/20; B60C 9/00

(52) U.S. Cl. CPC B60C 9/2003; B60C 9/005; B60C 9/0042; B60C 2009/2016; B60C 2009/2083; B60C 2009/2077; B60C 2009/2096

(57) ABSTRACT

A radial tire, notably for a passenger vehicle or van, has an improved belt structure comprising a multilayer composite laminate with a first layer of rubber comprising heat-shrinkable circumferential textile reinforcers, in the form of monofilament fibres twisted individually on themselves according to a twist greater than 100 turns per metre; this first layer radially (in the direction Z) surmounts two other layers of rubber, reinforced by reinforcers all or some of which are composite reinforcers made up of steel monofilaments sheathed with a thermoplastic material, the glass transition temperature of which is greater than 20° C. This laminate makes it possible to lighten the belts of tyres by reducing the thickness of the layers of rubber that make up part of their structure, and therefore to reduce the weight and rolling resistance of the tyres, without the risk of direct contact between the reinforcers.

### 1. FIELD OF THE INVENTION

The present invention relates to vehicle tyres and to the crown reinforcement or belt thereof. It relates more specifically to the multilayer composite laminates used in the belt of such tyres notably for passenger vehicles or vans.

### 2. PRIOR ART

A tyre with a radial carcass reinforcement for a passenger vehicle or van comprises, as is known, a tread, two inextensible beads, two flexible sidewalls connecting the beads to the tread and a rigid crown reinforcement or “belt” arranged circumferentially between the carcass reinforcement and the tread.

The tyre belt is generally made up of at least two rubber plies referred to as “working plies”, “triangulation plies” or else “working reinforcement” which are superposed and crossed, usually reinforced with metal cords disposed substantially parallel to one another and inclined with respect to the median circumferential plane, it being possible for these working plies to be associated or not to be associated with other plies and/or fabrics of rubber. These working plies have the primary function of giving the tyre high drift thrust or cornering stiffness which, in the known way, is necessary for achieving good road holding (“handling”) on the motor vehicle.

The above belt, and this is particularly true of tyres liable to run at sustained high speeds, may further comprise above the working plies (on the tread side) an additional rubber ply, referred to as “hooping ply” or “hoop reinforcement”, which is generally reinforced with reinforcing threads referred to as “circumferential”, which means to say that these reinforcing threads are disposed practically parallel to one another and extend substantially circumferentially around the tyre casing to form an angle preferably in a range from −5° to +5° with the median circumferential plane. The primary role of these circumferential reinforcing threads is, it should be remembered, to withstand the centrifuging of the crown at high speed.

Such belt structures, which ultimately consist of a multilayer composite laminate comprising at least one hooping ply, usually textile, and two working plies, generally of metal, are well known to a person skilled in the art and do not need to be described in greater detail here.

The general prior art describing such belt structures is illustrated in particular by patent documents U.S. Pat. No. 4,371,025, FR 2 504 067 or U.S. Pat. No. 4,819,705, EP 738 615, EP 795 426 or U.S. Pat. No. 5,858,137, EP 1 162 086 or US 2002/0011296, EP 1 184 203 or US 2002/0055583.

The availability of increasingly strong and durable steels means that tyre manufacturers are nowadays, as far as possible, tending towards the use in tyre belts of cords of a very simple structure, notably having just two threads, or even of individual filaments, in order on the one hand to simplify the manufacture and reduce costs, and on the other hand to reduce the thickness of the reinforcing plies and thus the hysteresis of the tyres, and ultimately to reduce the energy consumption of the vehicles fitted with such tyres.

However, efforts aimed at reducing the mass of the tyres, in particular by reducing the thickness of their belt and of the layers of rubber of which it is made, do, quite naturally, come up against physical limits which may give rise to a certain number of difficulties. In particular, it sometimes happens that the hooping function afforded by the hoop reinforcement and the stiffening function afforded by the working reinforcement are no longer sufficiently differentiated from one another and can interfere with one another. Of course, all of that is detrimental to the correct operation of the crown of the tyre, and to the performance and overall endurance of the tyre.

Thus, patent applications WO 2013/117476 and WO 2013/117477, filed by the applicant companies have proposed a multilayer composite laminate with a specific structure that allows the belt of the tyres to be lightened appreciably, and thus their rolling resistance to be lowered, while alleviating the abovementioned drawbacks.

These applications disclose a radial tyre, defining three main directions, circumferential, axial and radial, comprising a crown surmounted by a tread, two sidewalls, two beads, each sidewall connecting each bead to the crown, a carcass reinforcement that is anchored in each of the beads and extends in the sidewalls and into the crown, a crown reinforcement or belt that extends in the crown in the circumferential direction and is situated radially between the carcass reinforcement and the tread, the said belt comprising a multilayer composite laminate comprising at least three superposed layers of reinforcers, the said reinforcers being unidirectional within each layer and embedded in a thickness of rubber, with, notably:
on the tread side, a first layer of rubber comprising a first row of reinforcers which are oriented at an angle alpha of −5 to +5 degrees with respect to the circumferential direction, these reinforcers, referred to as first reinforcers, being made of a heat-shrinkable textile material;
in contact with the first layer and disposed beneath the latter, a second layer of rubber comprising a second row of reinforcers which are oriented at a given angle beta, which is positive or negative, of between 10 and 30 degrees with respect to the circumferential direction, these reinforcers, referred to as second reinforcers, being metal reinforcers;
in contact with the second layer and disposed beneath the latter, a third layer of rubber comprising a third row of reinforcers which are oriented at an angle gamma the opposite of the angle beta, itself being between 10 and 30 degrees with respect to the circumferential direction, these reinforcers, referred to as third reinforcers, being metal reinforcers.

The first reinforcers are made up of multifilament fibres, made of polyamide or of polyester, twisted together in a conventional way in the form of textile cords. The second and third reinforcers themselves consist of steel monofilaments, particularly made of very high strength carbon steel.

The above patent applications have demonstrated that it is possible, through the specific construction of their multilayer laminate, notably through the use of textile circumferential reinforcers the heat-shrinkability of which is controlled and of metal reinforcers in the form of individual monofilaments of small diameter, to achieve an appreciable reduction in the overall thickness of the belts of tyres, and to do so without detracting from the correct operation and differentiation of the functions, on the one hand, of hooping afforded by the circumferential reinforcers of the first layer and, on the other hand, of stiffening, afforded by the metal reinforcers of the two other layers.

Thus, the weight of the tyres and the rolling resistance thereof can be reduced, at low cost thanks to the use of steel monofilaments that do not require any prior assembly operation, and this can be achieved without penalty to the cornering stiffness and therefore roadholding or the overall endurance in driving.

It has nevertheless been found in use that, according to the particular conditions of implementation of the multilayer laminates described in the above applications, the reduction in thickness of the (first, second and third) layers of rubber could here and there run up against the risk of direct contact, or else of too great a proximity, in the radial direction (Z), between the reinforcers of these various layers. This may be detrimental to the correct operation and long-term endurance of the multilayer composite laminate.

For example, direct contact or excessive proximity between, on the one hand, the textile circumferential threads, which are known naturally to contain a certain quantity of water, that can vary according to the nature of the heat-shrinkable textile material, and, on the other hand, the steel monofilaments, could give rise to surface corrosion of the latter, not to mention to a risk of impaired adhesion to the surrounding rubber.

Direct contact between the steel monofilaments of the second layer and those of the third layer which, let it be remembered, are crossed relative to one another within the working reinforcement, may itself lead to repeated friction and premature wearing of these monofilaments under working conditions, and ultimately to a risk of an impairment of the overall endurance of this working reinforcement after the tyres have been extensively driven on.

### 3. BRIEF DESCRIPTION OF THE INVENTION

In continuing their research, the applicant companies have developed an improved multilayer composite laminate, of novel architecture, which makes it possible at least in part to alleviate the aforementioned problems caused by risks of direct contact between the reinforcers, and which may advantageously replace the laminates described in the two aforementioned applications.

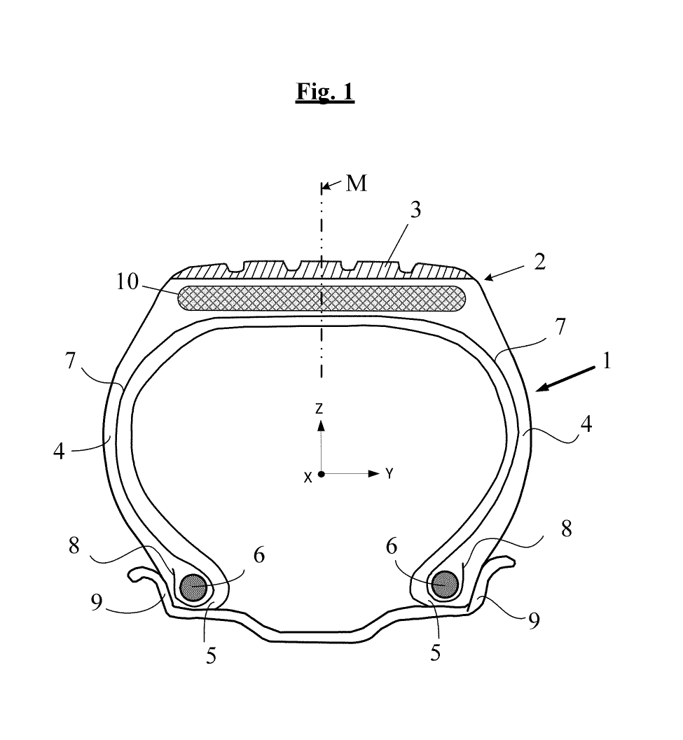

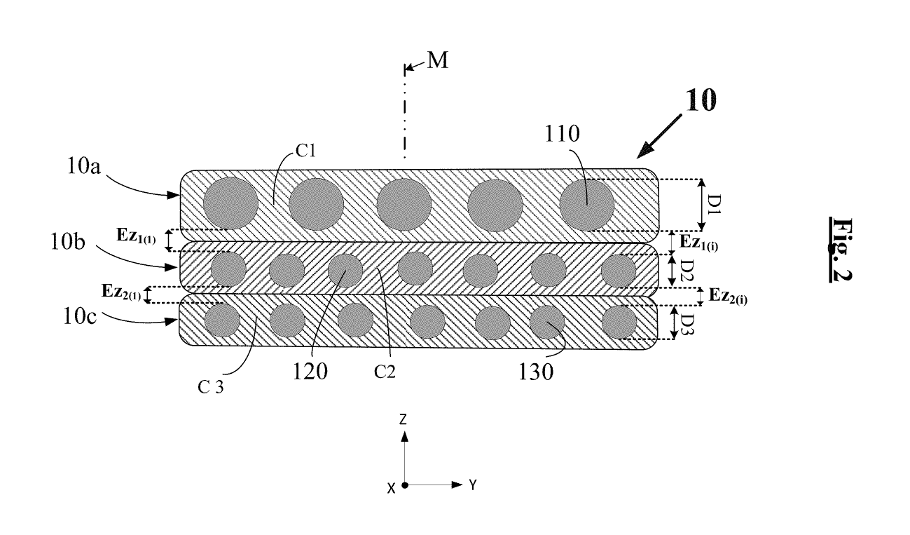

Thus, a first subject of the present invention relates (according to the references given in the appended FIGS. 1 and 2) to a radial tyre (1), defining three main directions, circumferential (X), axial (Y) and radial (Z), comprising a crown (2) surmounted by a tread (3), two sidewalls (4), two beads (5), each sidewall (4) connecting each bead (5) to the crown (2), a carcass reinforcement (7) that is anchored in each of the beads (5) and extends in the sidewalls (4) as far as the crown (2), a crown reinforcement or belt (10) that extends in the crown (2) in the circumferential direction (X) and is situated radially between the carcass reinforcement (7) and the tread (3), the said belt (10) comprising a multilayer composite laminate (10a, 10b, 10c) comprising at least three superposed layers of reinforcers (110, 120, 130), the said reinforcers being unidirectional within each layer and embedded in a thickness of rubber (C1, C2, C3 respectively), with:
on the tread side, a first layer (10a) of rubber (C1) comprising a first row of reinforcers (110) which are oriented at an angle alpha of −5 to +5 degrees with respect to the circumferential direction (X), these reinforcers (110), referred to as first reinforcers, having an envelope diameter, denoted D1, of between 0.30 mm and 0.60 mm and being made of a heat-shrinkable textile material;
in contact with the first layer (10b) and disposed beneath the latter, a second layer (10b) of rubber (C2) comprising a second row of reinforcers (120) which are oriented at a given angle beta, which is positive or negative, of between 10 and 30 degrees with respect to the circumferential direction (X), these reinforcers (120), referred to as second reinforcers, having a diameter or thickness, denoted D2, of between 0.20 mm and 0.50 mm;
in contact with the second layer (10b) and disposed beneath the latter, a third layer (10c) of rubber (C3) comprising a third row of reinforcers (130) which are oriented at an angle gamma the opposite of the angle beta, itself being between 10 and 30 degrees with respect to the circumferential direction (X), these reinforcers (130), referred to as third reinforcers, having a diameter or thickness, denoted D3, of between 0.20 mm and 0.50 mm,
characterized in that:
all or part of the first reinforcers (110) made of heat-shrinkable textile material are multifilament fibres twisted individually on themselves according to a twist T greater than 100 turns per metre;
all or part of the second (120) and/or third (130) reinforcers are composite reinforcers comprising steel monofilaments (120a, 130a) which are covered with a sheath (120b, 130b) of a thermoplastic material the glass transition temperature Tg of which is higher than 20° C.

The invention thus offers the possibility, depending on the particular applications targeted, to maintain a low level or even to further reduce the thickness of the belts of tyres and that of the layers of rubber that make up part of their structure, and therefore ultimately the weight and rolling resistance of the tyres without the risk of direct contact between the various reinforcers.

The thermoplastic sheath also constitutes an effective barrier against the corrosive agents liable to penetrate the multilayer laminate in the event of attack on the tyre. Furthermore, because this sheath has a stiffness that is somewhere between the stiffness of the steel monofilaments and the stiffness of the rubber matrix with which they are coated, the stresses applied at the interfaces are lower, and this is liable to further improve the overall endurance of the multilayer laminate of the tyre of the invention.

The multilayer composite laminate according to the invention can be used as a belt reinforcing element for any type of tyre, particularly for passenger vehicles notably including 4×4s and SUVs (Sport Utility Vehicles) or for vans.

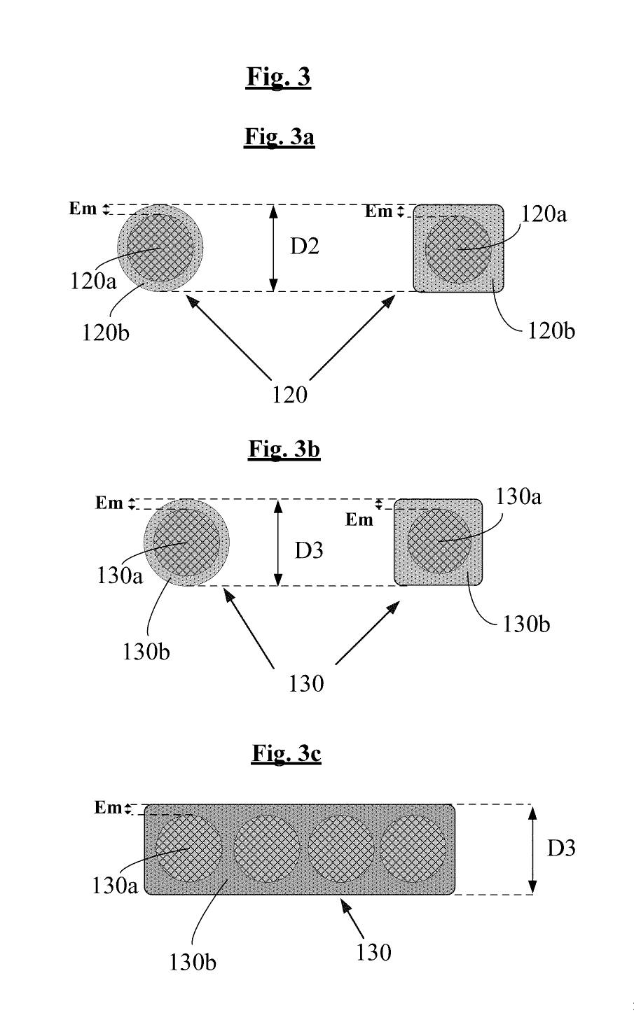

The invention and its advantages will be readily understood in the light of the following detailed description and exemplary embodiments, and also FIGS. 1 to 3 relating to these embodiments, which schematically show (unless otherwise indicated, not to a specific scale):
in radial section (which means a section in a plane containing the axis of rotation of the tyre), an example of a tyre (1) according to the invention, incorporating within its belt (10) a multilayer composite laminate according to the invention (FIG. 1);
in cross section, an example of a composite multilayer (10a, 10b, 10c) laminate (10) that can be used in the tyre (1) according to the invention, incorporating the heat-shrinkable textile reinforcers (110) in the form of a multifilament fibre twisted on itself (FIG. 2) and reinforcers (120, 130) (FIG. 2);
in cross section, examples of reinforcers (respectively 120, 130) in the form of composite reinforcers (120a, 120b, 130a, 130b) that can be used in the multilayer laminate according to the invention, made up of steel monofilaments (respectively 120a, 130a) which are covered with a sheath (respectively 120b, 130b) of a thermoplastic material, the sheath being able to take different cross-sectional forms, for example with circular, square or rectangular outlines (FIG. 3; respectively FIGS. 3a, 3b and 3c).

### 4. DEFINITIONS

In the present application, the following definitions are adopted:
“rubber” or “elastomer” (the two terms being considered to be synonymous): any type of elastomer, be it of the diene type or the non-diene type, for example thermoplastic;
“rubber composition” or “rubbery composition”: a composition which contains at least one rubber and one filler;
“layer”: a sheet, strip or any other element the thickness of which is relatively small compared to its other dimensions, preferably of which the ratio of the thickness to the largest of the other dimensions is less than 0.5, more preferably less than 0.1;
“axial direction”: a direction substantially parallel to the axis of rotation of the tyre;
“circumferential direction”: a direction which is substantially perpendicular both to the axial direction and to a radius of the tyre (in other words, tangential to a circle the centre of which lies on the axis of rotation of the tyre);
“radial direction”: a direction along a radius of the tyre, that is to say any direction that passes through the axis of rotation of the tyre and is substantially perpendicular to this direction, that is to say making an angle of no more than 5 degrees with a perpendicular to this direction;
a “monofilament” generally means any individual filament, whatever the shape of its cross section, the diameter (in the case of a circular cross section) or thickness (in the case of a non-circular cross section) of which is greater than 100 μm. This definition equally covers monofilaments of essentially cylindrical shape (with circular cross section) and monofilaments of other shapes, for example oblong monofilaments (of flattened shape) or of rectangular or square cross section;
“oriented along an axis or in a direction”, when speaking of any element such as a reinforcer, means an element which is oriented substantially parallel to this axis or this direction, that is to say that makes an angle of not more than 5 degrees (which is therefore zero or at most equal to 5 degrees) with this axis or this direction;
“oriented perpendicularly to an axis or a direction”: when speaking of any element such as a reinforcer, an element which is oriented substantially perpendicularly to this axis or this direction, that is to say making an angle of no more than 5 degrees with a perpendicular to this axis or this direction;
“median circumferential plane” (denoted M): the plane perpendicular to the axis Y of rotation of the tyre which is situated mid-way between the two beads and passes through the middle of the crown reinforcement or belt;
“reinforcer” or “reinforcing thread”: any long and slender strand, that is to say any longilinear, filiform strand with a length that is long in relation to its cross section, notably any individual filament, any multifilament fibre or any assembly of such filaments or fibres such as a folded yarn or a cord, it being possible for this strand or thread to be rectilinear or non-rectilinear, for example twisted, or crimped, such a strand or thread being able to reinforce a rubber matrix (that is to say to improve the tensile properties of the matrix);
“unidirectional reinforcers”: reinforcers that are essentially mutually parallel, that is to say oriented along one and the same axis;
“laminate” or “multilayer laminate”: within the meaning of the International Patent Classification, any product comprising at least two layers, of flat or non-flat form, which are in contact with one another, it being possible for the latter to be or not to be joined, and connected together; the expression “joined” or “connected” should be interpreted broadly so as to include all means of joining or assembling, in particular via adhesive bonding.

Moreover, unless expressly indicated otherwise, all the percentages (%) shown are % by weight.

The expression “x and/or y” means “x” or “y” or both (namely “x and y”). Any range of values denoted by the expression “between a and b” represents the field of values ranging from more than “a” to less than “b” (that is to say endpoints “a” and “b” excluded) whereas any range of values denoted by the expression “from “a” to “b” means the field of values ranging from “a” up to “b” (that is to say including the strict limits “a” and “b”).

### 5. DETAILED DESCRIPTION AND EXEMPLARY EMBODIMENTS OF THE INVENTION

By way of example, FIG. 1 very schematically shows (that is to say without being drawn to any particular scale) a radial section through a tyre according to the invention, for example for a vehicle of the passenger vehicle or van type, the belt of which comprises a multilayer composite laminate according to the invention.

This tyre (1) according to the invention, defining three perpendicular directions, circumferential (X), axial (Y) and radial (Z), comprises a crown (2) surmounted by a tread (3), two sidewalls (4), two beads (5), each sidewall (4) connecting each bead (5) to the crown (2), a carcass reinforcement (7) that is anchored in each of the beads (5) and extends in the sidewalls (4) as far as the crown (2), a crown reinforcement or belt (10) that extends in the crown (2) in the circumferential direction (X) and is situated radially between the carcass reinforcement (7) and the tread (3). The carcass reinforcement (7) is, in the known way, made up of at least one rubber ply reinforced with textile cords referred to as “radial”, which are disposed practically parallel to one another and extend from one bead to the other so as to make an angle of generally between 80° and 90° with the median circumferential plane M; in this case, by way of example, it is wrapped around two bead wires (6) in each bead (5), the turn-up (8) of this reinforcement (7) being, for example, disposed towards the outside of the tyre (1) which is shown in this case as mounted on its rim (9).

According to the present invention, and in accordance with the depictions in FIGS. 2 and 3 which will be described in detail later on, the belt (10) of the tyre (1) comprises a multilayer composite laminate comprising three superposed layers (10a, 10b, 10c) of reinforcers, the said reinforcers being unidirectional within each layer and embedded in a thickness of rubber (C1, C2, C3, respectively), with:
on the tread side, a first layer (10a) of rubber (C1) comprising a first row of reinforcers (110) which are oriented at an angle alpha of −5 to +5 degrees with respect to the circumferential direction (X), these reinforcers (110), referred to as first reinforcers, having an envelope diameter, denoted D1, of between 0.30 mm and 0.60 mm and being made of a heat-shrinkable textile material;
in contact with the first layer (10b) and disposed beneath the latter, a second layer (10b) of rubber (C2) comprising a second row of reinforcers (120) which are oriented at a given angle beta, positive or negative, of between 10 and 30 degrees with respect to the circumferential direction (X), these reinforcers (120), referred to as second reinforcers, having a diameter or thickness, denoted D2, of between 0.20 mm and 0.50 mm;
in contact with the second layer (10b) and disposed beneath the latter, a third layer (10c) of rubber (C3) comprising a third row of reinforcers (130) which are oriented at an angle gamma the opposite of the angle beta, itself being between 10 and 30 degrees with respect to the circumferential direction (X), identical to or different from the angle beta, these reinforcers (130), referred to as third reinforcers, having a diameter or thickness, denoted D3, of between 0.20 mm and 0.50 mm.

According to the invention, the angles β and γ, of opposite direction, which are both between 10° and 30°, may be identical or different, that is to say that the second (120) and third (130) reinforcers may be disposed symmetrically or non-symmetrically on each side of the median circumferential plane (M) defined above.

In this tyre shown schematically in FIG. 1, it will of course be understood that the tread (3), the multilayer laminate (10) and the carcass reinforcement (7) may or may not be in contact with one another, even though these parts have been deliberately separated in FIG. 1, schematically, for the sake of simplicity and to make the drawing clearer. They could be physically separated, at the very least for a portion of them, for example by tie gums, well known to a person skilled in the art, that are intended to optimize the cohesion of the assembly after curing or crosslinking.

In the tyre of the invention, according to a first essential feature, all or part of the first reinforcers (110) made of heat-shrinkable textile material are multifilament fibres twisted individually on themselves according to a twist T greater than 100 tr/m (turns per metre).

In other words, all or part of these first reinforcers (110) are each made up of a unitary multifilament fibre (with a single strand) which is twisted individually on itself, commonly called “overtwist” as opposed to a twist in which, as is well known, at least two fibres (or strands) are first of all twisted individually in a given direction (for example in the direction S) then the (at least) two are twisted together in the opposite direction (direction Z) to finally constitute this twist by assembly of at least two strands.

The (individual) twist denoted T of this multifilament fibre preferably lies between 100 and 450 tr/m, more preferentially in a range from 120 to 350 tr/m, in particular in a range from 140 to 300 tr/m.

The linear density or titer of the multifilament fibres preferably is between 50 and 250 tex (g/1000 m of fibre), more preferentially in a range from 65 to 200 tex.

The (mean) envelope diameter, D1, of these first textile reinforcers (110) is itself between 0.30 mm and 0.60 mm, preferably between 0.35 mm and 0.55 mm, particularly in the range of from 0.40 mm to 0.50 mm; what is meant in the usual way by envelope diameter is the diameter of the imaginary cylinder of revolution surrounding such first textile reinforcers (110) in the event that the latter are not of circular cross section.

Preferably, the thermal contraction (denoted CT) of the first reinforcers (110) made of heat-shrinkable textile material, after 2 min at 185° C., is less than 7.5%, more preferably less than 7.0%, particularly less than 6.0%, which values have proven to be preferable for the manufacturing and dimensional stability of the tyre casings, particularly during the phases of curing and cooling thereof.

This relates to the relative contraction of these first reinforcers (110) under the test conditions mentioned below. The parameter CT is measured, unless specified otherwise, in accordance with the standard ASTM D1204-08, for example on an apparatus of the “Testrite” type under what is known as a standard pretension of 0.5 cN/tex (which is therefore expressed with respect to the titer or linear density of the test specimen being tested). At constant length, the maximum force of contraction (denoted F_{C}) is also measured using the above test, this time at a temperature of 180° C. and under 3% elongation. This force of contraction F_{C} is preferably greater than 10 N (Newtons). A high force of contraction has proven to be particularly beneficial to the hooping capability of the first reinforcers (110) made of heat-shrinkable textile material with respect to the crown reinforcement of the tyre when the latter heats up under high running speeds.

The above parameters CT and F_{C} can be measured without distinction on the adhesive-coated initial textile reinforcers before they are incorporated into the laminate and then into the tyre, or alternatively can be measured on these reinforcers once they have been extracted from the central zone of the vulcanized tyre and preferably “derubberized” (that is to say rid of the rubber which coats them in the layer C1).

Any heat-shrinkable textile material is suitable, and in particular and preferably a textile material that satisfies the contraction features CT mentioned above is suitable.

Preferably, this heat-shrinkable textile material is selected from the group consisting of polyamides, polyesters and polyketones. Mention may especially be made, among the polyamides (or nylons), of the polyamides 4-6, 6, 6-6, 11 or 12. Mention may be made, among polyesters, for example of PET (polyethylene terephthalate), PEN (polyethylene naphthalate), PBT (polybutylene terephthalate), PBN (polybutylene naphthalate), PPT (polypropylene terephthalate), and PPN (polypropylene naphthalate).

More preferably, the heat-shrinkable textile material of which the first reinforcers (110) are made is a polyamide (nylon) or a polyester.

Preferentially, the multifilament fibres twisted individually on themselves represent the majority (by definition the majority in number), preferably all of the first (110) reinforcers of the first layer (10a) of rubber (C1).

By virtue of their greater compactness, these overtwists present the advantage, compared to textile cords formed from multifilament fibres conventionally twisted together, of better protecting the rest of the multilayer composite laminate against moisture, and of limiting the risks of compromising the adhesion between the various reinforcers of the laminate and their surrounding rubber matrix, not to mention the risks of surface corrosion of the steel monofilaments.

In the tyre of the invention, according to a second essential feature, all or part of the second (120) and/or third (130) reinforcers are composite reinforcers comprising steel monofilaments (120a, 130a) which are covered with a sheath (120b, 130b) of a thermoplastic material, these monofilaments, let it be remembered, not being twisted or cabled together but used in the individual state.

The glass transition temperature Tg of the thermoplastic material is greater than 20° C.; it is preferably greater than 50° C., more preferably greater than 70° C. Its melting point (denoted Tf) is typically greater than 150° C., more preferably greater than 200° C.

Tg and Tf are measured in a known manner by DSC (Differential Scanning calorimetry), at the second pass, for example, and unless otherwise indicated in the present application, according to standard ASTM D3418 of 1999 (“822-2” DSC apparatus from Mettler Toledo; nitrogen atmosphere; samples first brought from ambient temperature (23° C.) to 250° C. (10° C./min), then rapidly cooled down to 23° C., before final recording of the DSC curve from 23° C. to 250° C., at a ramp of 10° C./min).

The minimum thickness, denoted Em, of the thermoplastic sheath (120b, 130b) covering the steel monofilaments (120a, 130a) of the second (120) and/or third (130) (more preferably second and third) composite reinforcers as depicted in FIGS. 3a, 3b and 3c is preferably between 5 and 150 μm, more preferably between 10 and 100 μm, and in particular between 15 and 50 μm.

Because this thermoplastic sheath has a stiffness that is somewhere between the stiffness of the steel monofilaments and the stiffness of the rubber matrix with which they are coated, the stresses applied at the interfaces are lower, and this is liable to further improve the overall endurance of the multilayer laminate of the tyre of the invention.

Typically, the thermoplastic material is a polymer or a polymeric composition (namely a composition based on at least one polymer and on at least one additive).

This thermoplastic polymer is preferably selected from the group consisting of polyamides, polyesters and polyimides and mixtures of such polymers; more particularly, this polymer is a polyamide or a polyester. Mention may especially be made, among the (aliphatic) polyamides, of the polyamides 4-6, 6, 6-6, 11 or 12. Mention may be made, among polyesters, more particularly of PET (polyethylene terephthalate), PEN (polyethylene naphthalate), PBT (polybutylene terephthalate), PBN (polybutylene naphthalate), PPT (polypropylene terephthalate), and PPN (polypropylene naphthalate).

Various additives such as a dye, filler, plasticizer, antioxidant or other stabilizer may be optionally added to the above polymer or mixture of polymers in order to form a polymeric composition. Compatible components, preferably themselves thermoplastic, capable of promoting the adhesion to a diene rubber matrix, for example TPS (thermoplastic styrene) elastomers of unsaturated type, especially that are epoxidized, as described for example in applications WO 2013/117474 and WO 2013/117475, could advantageously be added to the above thermoplastic material.

In one preferred embodiment, the sheath comprises a single layer of thermoplastic material. As an alternative, the sheath could nevertheless comprise several distinct layers, at least one of them, or even all of them, being a thermoplastic material. Thus, the various materials and layers described in the applications WO2010/136389, WO2010/105975, WO2011/012521, WO2011/051204, WO2012/016757, WO2012/038340, WO2012/038341, WO2012/069346, WO2012/104279, WO2012/104280 and WO2012/104281 may be used.

The second (120) and third (130) reinforcers according to the invention have a diameter (or, by definition, a thickness if their cross section is non-circular), denoted D2 and D3 respectively, which is between 0.20 mm and 0.50 mm. D2 and D3 may be identical or different from one layer to the other; if they are different, D3 may be greater than D2 or indeed less than D2, depending on the particular embodiments of the invention.

For preference, D2 and/or D3 (more preferably D2 and D3) are greater than 0.25 mm and less than 0.40 mm. More preferably, for optimal endurance of the tyre of the invention, notably under harsh running conditions, it is preferable for D2 and/or D3 (more preferably D2 and D3) to be in a range from 0.28 to 0.35 mm.

Preferably, the steel is a carbon steel such as, for example, the steels used in cords of the “steel cords” type for tyres; however it is of course possible to use other steels, for example stainless steels, or other alloys.

According to one preferred embodiment, when a carbon steel is used, its carbon content (% by weight of steel) is in a range from 0.5% to 1.2%, more preferably from 0.7% to 1.0%. The invention applies in particular to steels of the normal tensile (NT) or high tensile (HT) steel cord type, the (second and third) reinforcers made of carbon steel then having a tensile strength (Rm) which is preferably higher than 2000 MPa, more preferably higher than 2500 MPa. The invention also applies to super high tensile (SHT), ultra high tensile (UHT) or megatensile (MT) steels of the steel cord type, the (second and third) reinforcers made of carbon steel then having a tensile strength (Rm) which is preferably higher than 3000 MPa, more preferably higher than 3500 MPa. The total elongation at break (At) of these reinforcers, which is the sum of the elastic elongation and the plastic elongation, is preferably greater than 2.0%.

As far as the (second and third) reinforcers made of steel are concerned, the measurements of force at break, strength at break denoted Rm (in MPa) and elongation at break denoted At (total elongation in %) are taken under tension in accordance with ISO standard 6892 of 1984.

The steel used, whether it is in particular a carbon steel or a stainless steel, may itself be coated, prior to sheathing with the thermoplastic material, with a layer of metal which improves for example the workability properties of the steel monofilament or the wear properties of the reinforcer and/or of the tyre themselves, such as the properties of adhesion, corrosion resistance or even resistance to ageing. The steel may for example be covered with a layer of brass (Zn—Cu alloy) or of zinc; it will notably be recalled that, during the process of manufacturing the wires, the brass or zinc coating makes the wire easier to draw, and makes the wire adhere to the rubber more readily.

The step of sheathing or covering the steel monofilaments with the thermoplastic material is performed in a way well known to those skilled in the art, for example by passing the monofilament or even, where appropriate, several monofilaments disposed in parallel, through one or more dies of suitable diameter, in extrusion heads heated to suitable temperatures, or even through a coating bath containing thermoplastic material dissolved beforehand in a suitable organic solvent (or mixture of solvents). On exiting the extrusion head, the filament(s) thus sheathed are then cooled sufficiently so as to solidify the layer of thermoplastic material, for example with air or another cold gas, or by passing through a water bath, followed by a drying stage. Advantageously, before deposition of the sheath of thermoplastic material, the steel monofilaments may be subjected to an adhesion treatment in order to improve the subsequent adhesion between the steel and the thermoplastic sheath.

For preference, the sheath of thermoplastic material is then provided with an adhesive layer facing each layer of rubber composition with which it is in contact. In order to adhere the rubber to this thermoplastic material, use could be made of any appropriate adhesive system, for example a simple textile adhesive of the “RFL” (resorcinol-formaldehyde-latex) type comprising at least one diene elastomer such as natural rubber, or any equivalent adhesive known for imparting satisfactory adhesion between rubber and conventional thermoplastic fibres such as polyester or polyamide fibres, such as for example the adhesive compositions described in the applications WO 2013/017421, WO 2013/017422, WO 2013/017423.

By way of example, the adhesive coating process may essentially comprise the following successive steps: passage through a bath of adhesive, followed by drainage (for example by blowing, grading) to remove the excess adhesive; then drying, for example by passing into an oven or heating tunnel (for example for 30 s at 180° C.) and finally heat treatment (for example for 30 s at 230° C.).

Before the above adhesive coating process, it may be advantageous to activate the surface of the thermoplastic material, for example mechanically and/or physically and/or chemically, to improve the adhesive uptake thereof and/or the final adhesion thereof to the rubber. A mechanical treatment could consist, for example, of a prior step of matting or scratching the surface; a physical treatment could consist, for example, of a treatment via radiation such as an electron beam; a chemical treatment could consist, for example, of prior passage through a bath of epoxy resin and/or isocyanate compound.

Since the surface of the thermoplastic material is, as a general rule, smooth, it may also be advantageous to add a thickener to the adhesive used, in order to improve the total uptake of adhesive by the multicomposite reinforcer during the adhesive coating thereof.

A person skilled in the art will readily understand that the connection between the thermoplastic sheath and each layer of rubber with which it is in contact is definitively provided during the final curing (crosslinking) of the tyre casing for which the laminate is intended.

According to one preferred embodiment of the invention, the steel monofilaments sheathed with the thermoplastic sheath represent the majority (by definition, majority by number), more preferably all, of the second reinforcers (120) of the second layer (10b) of rubber (C2). According to another preferred embodiment, which may or may not be combined with the preceding one, the steel monofilaments sheathed with the thermoplastic sheath represent the majority, more preferably all, of the third reinforcers (130) of the third layer (10c) of rubber (C3).

Each layer (C1, C2, C3) of rubber composition (or “layer of rubber” below) of which the multilayer composite laminate is made is based on at least one elastomer and one filler.

For preference, the rubber is a diene rubber, that is to say, as will be recalled, any elastomer (single elastomer or blend of elastomers) which is derived, at least in part (i.e. a homopolymer or copolymer) from diene monomers, that is to say monomers which bear two carbon-carbon double bonds, whether these are conjugated or not.

This diene elastomer is more preferably selected from the group consisting of polybutadienes (BRs), natural rubber (NR), synthetic polyisoprenes (IRs), butadiene copolymers, isoprene copolymers and blends of these elastomers, such copolymers being notably selected from the group consisting of butadiene-styrene copolymers (SBRs), isoprene-butadiene copolymers (BIRs), isoprene-styrene copolymers (SIRs) and isoprene-butadiene-styrene copolymers (SBIRs).

One particularly preferred embodiment consists in using an “isoprene” elastomer, that is to say an isoprene homopolymer or copolymer, in other words a diene elastomer selected from the group consisting of natural rubber (NR), synthetic polyisoprenes (IRs), the various isoprene copolymers and mixtures of these elastomers.

The isoprene elastomer is preferably natural rubber or a synthetic polyisoprene of the cis-1,4 type. Among these synthetic polyisoprenes, use is preferably made of polyisoprenes having a content (mol %) of cis-1,4 bonds of greater than 90%, even more preferably greater than 98%. According to one preferred embodiment, each layer of rubber composition contains 50 to 100 phr of natural rubber. According to other preferred embodiments, the diene elastomer may consist, in full or in part, of another diene elastomer such as, for example, an SBR elastomer used as a blend with another elastomer, for example of the BR type, or used alone.

Each rubber composition may comprise just one or several diene elastomer(s) as well as all or some of the additives customarily used in the rubber matrices intended for the manufacture of tyres, such as for example reinforcing fillers such as carbon black or silica, coupling agents, anti-ageing agents, antioxidants, plasticizing agents or extender oils, whether the latter are of aromatic or non-aromatic nature (notably very weakly aromatic or non-aromatic oils, for example of the naphthene or paraffin type, with high or preferably low viscosity, MES or TDAE oils), plasticizing resins with a high glass transition temperature (above 30° C.), agents that aid with processing (processability of) the compositions in the raw state, tackifying resins, antireversion agents, methylene acceptors and donors such as, for example, HMT (hexamethylenetetramine) or H3M (hexamethoxymethylmelamine), reinforcing resins (such as resorcinol or bismaleimide), known adhesion promoting systems of the metal salts type for example, notably salts of cobalt, of nickel or of lanthanide, a cross-linking or vulcanization system.

Preferably, the system for crosslinking the rubber composition is a system referred to as a vulcanization system, that is to say one based on sulphur (or on a sulphur donor agent) and a primary vulcanization accelerator. Various known secondary vulcanization accelerators or vulcanization activators may be added to this basic vulcanization system. Sulphur is used at a preferred content of between 0.5 and 10 phr, and the primary vulcanization accelerator, for example a sulphenamide, is used at a preferred content of between 0.5 and 10 phr. The content of reinforcing filler, for example of carbon black and/or silica, is preferably higher than 30 phr, notably between 30 and 100 phr.

All carbon blacks, in particular blacks of the HAF, ISAF or SAF type, conventionally used in tyres (“tyre-grade” blacks) are suitable as carbon blacks. Mention will more particularly be made, among the latter, of the carbon blacks of 300, 600 or 700 (ASTM) grade (for example, N326, N330, N347, N375, N683 or N772). Precipitated or fumed silicas having a BET surface area of less than 450 m²/g, preferably from 30 to 400 m²/g, are notably suitable as silicas.

A person skilled in the art will know, in light of the present description, how to adjust the formulation of the rubber compositions in order to achieve the desired levels of properties (especially modulus of elasticity), and how to adapt the formulation to suit the specific application envisaged.

Preferably, each rubber composition has, in the crosslinked state, a secant modulus in extension, at 10% elongation, of between 4 and 25 MPa, more preferably between 4 and 20 MPa; values notably between 5 and 15 MPa have proven to be particularly suitable. Modulus measurements are carried out in tensile tests, unless otherwise indicated in accordance with the standard ASTM D 412 of 1998 (test specimen “C”): the “true” secant modulus (that is to say the one with respect to the actual cross section of the test specimen) is measured in second elongation (that is to say after an accommodation cycle) at 10% elongation, denoted here by Ms and expressed in MPa (under standard temperature and relative humidity conditions in accordance with the standard ASTM D 1349 of 1999).

In order to cause the first, second and third reinforcers to adhere to their three respective layers of rubber (C1, C2, C3) described above, use may be made of any suitable adhesive system, for example a textile glue of the “RFL” (resorcinol-formaldehyde-latex) or equivalent type regarding the first textile reinforcers and the steel monofilaments sheathed with their thermoplastic material.

The tyre of the invention has, by way of other preferred features, at least one and preferably both of the following:
the density d₁ of the first reinforcers (110) in the first layer of rubber (C1), measured in the axial direction (Y), is comprised between 90 and 150 threads/dm (decimetre, namely per 100 mm of rubber layer);
the density, denoted d₂ and d₃ respectively, of the second (120) and third (130) reinforcers in the second (C2) and third (C3) layers of rubber respectively, measured in the axial direction (Y), is comprised between 100 and 180 threads/dm.

More preferably, at least one and preferably both of the following two features are satisfied:
the density d₁ is between 100 and 140 threads/dm;
the densities d₂ and d₃ are between 110 and 170, more preferably still between 120 and 160 threads/dm.

Furthermore, and according to another preferred embodiment of the invention, at least one of the following features is satisfied (more preferably all three of them):
the mean thickness Ez₁ of rubber separating a first reinforcer (110) of the first layer (C1) from the second reinforcer (120) of the second layer (C2) closest to it, measured in the radial direction (Z), is less than 0.40 mm, more preferably between 0.20 and 0.40 mm and in particular between 0.20 and 0.35 mm;
the mean thickness Ez₂ of rubber separating a second reinforcer (120) of the second layer (C2) from the third reinforcer (130) of the third layer (C3) closest to it, measured in the radial direction (Z), is less than 0.60 mm, more preferably between 0.35 and 0.60 mm, particularly between 0.35 and 0.55 mm;
the total thickness of the multilayer composite laminate, namely of its three superposed layers (C1, C2, C3), measured in the radial direction Z, is comprised between 1.8 and 2.7 mm, in particular between 2.0 and 2.5 mm.

All the data (D1, D2, D3, Em, d₁, d₂, d₃, Ez₁, Ez₂ and total thickness) indicated above are mean values measured experimentally by an operator on photographs of radial sections of vulcanized tyres taken through the central part of the belt, 5 cm on each side of the median plane (M), namely over a total width of 10 cm (namely between −5 cm and +5 cm with respect to the median plane M).

FIG. 2 schematically (and without being drawn to any particular scale) depicts, in cross section, one example of the multilayer composite laminate (10a, 10b, 10c) used as a belt (10) in the tyre (1) according to the invention of FIG. 1, the laminate (10) incorporating:
reinforcers (110) made of heat-shrinkable textile material (for example of polyester or polyamide) respectively in the form of a multifilament fibre twisted on itself according to a twist greater than 100 tr/m;
second (120) and/or third (130) composite reinforcers, as illustrated in more detail in FIG. 3, comprising steel monofilaments (120a, 130a) which are covered with a sheath (120b, 130b) of a thermoplastic material with a Tg greater than 20° C., for example made of polyester or of polyamide.

By way of examples, the sheath (120b, 130b) may be circular, square or indeed rectangular (FIGS. 3a, 3b and 3c). It could also for example be oblong in shape.

The steel monofilaments sheathed with the thermoplastic material may be sheathed individually as indicated by way of examples in FIGS. 3a and 3b, this constituting a preferred embodiment. However, according to another preferred embodiment, it is several steel monofilaments (all or some of the reinforcers 120 and/or 130 of the laminate) which may be sheathed collectively with the same thermoplastic sheath, as indicated by way of example in FIG. 3c in which the final reinforcer 130 here consists of 4 steel monofilaments (130a) which have been sheathed collectively in a single thermoplastic sheath (130b).

It should be emphasized that the use of one and the same thermoplastic material, for example polyester or polyamide, from which to make on the one hand the heat-shrinkable textile material and, on the other hand, the material used to sheath the steel monofilaments, may prove particularly advantageous because there are then no problems of compatibility between the respective reinforcers, particularly in the event of unwanted direct contact between the latter.

As illustrated in FIG. 2, Ez₁ is the mean of the thicknesses (Ez₁₍₁₎, Ez₁₍₂₎, Ez₁₍₃₎, . . . , Ez₁₍ᵢ₎) of rubber separating a first reinforcer (110) from the second reinforcer (120) closest to it, these thicknesses each being measured in the radial direction Z and averaged over a total axial distance of between −5.0 cm and +5.0 cm with respect to the centre of the belt (namely, for example, in total around 100 measurements if there are ten reinforcers (110) per cm in the layer C1).

Expressed differently, Ez₁ is the mean of the minimum distances Ez₁₍ᵢ₎ separating each first reinforcer (110) “back-to-back” from the second reinforcer (120), of course with the sheath included, closest to it in the radial direction Z, this mean being calculated over all the first reinforcers (110) present in the central part of the belt, in an axial interval extending between −5 cm and +5 cm with respect to the median plane M.

Similarly, Ez₂ is the mean of the thicknesses of rubber (Ez₂₍₁₎, Ez₂₍₂₎ Ez₂₍₃₎, . . . , Ez₂₍ᵢ₎) separating a second reinforcer (120) from the third reinforcer (130) closest to it, measured in the radial direction Z, this mean being calculated over a total axial distance of between −5.0 cm and +5.0 cm with respect to the centre of the belt. Expressed another way, these thicknesses represent the minimum distances which separate the second reinforcer (120) “back-to-back” from the third reinforcer (130) closest to it in the radial direction Z.

Expressed another way, Ez₂ is the mean of the minimum distances Ez₂₍ᵢ₎ separating each second reinforcer (120) “back-to-back” from the third reinforcer (130) of course with the sheaths included, closest to it in the radial direction Z, this mean being calculated over all the second reinforcers (120) present in the central part of the belt, in an axial interval extending between −5 cm and +5 cm with respect to the median plane M.

For an optimized performance in terms of rolling resistance, drift thrust and running endurance, the tyre of the invention preferably satisfies at least one of the following inequalities (more preferably all three):

0.15<Ez₁/(Ez₁+D1+D2)<0.30

0.20<Ez₂/(Ez₂+D2+D3)<0.50

0.20<(Ez₁+Ez₂)/(Ez₁+Ez₂+D1+D2+D3)<0.40.

In conclusion, the invention offers the possibility of keeping down or even of reducing still further the thickness of the belts of tyres and that of the layers of rubber that make up part of the structure thereof, and ultimately the weight and rolling resistance of the tyres, without the risk of direct contact between the various reinforcers.

The multilayer composite laminate is better protected from moisture thanks to the use in its first layer of multifilament textile fibres twisted individually on themselves.

The thermoplastic sheath also acts as an effective barrier against corrosive agents liable to penetrate the multilayer laminate in the event of attack on the tyre. Finally, because this sheath has a stiffness that is somewhere between the stiffness of the steel monofilaments and the stiffness of the rubber matrix with which they are coated, the stresses applied at the interfaces are lower, and this is liable to further improve the overall endurance of the multilayer composite laminate of the tyre of the invention.

1.-25. (canceled)

26. A radial tire, defined in three main directions, circumferential, axial and radial, comprising a crown surmounted by a tread, two sidewalls, two beads, each sidewall connecting each bead to the crown, a carcass reinforcement that is anchored in each of the beads and extends in the sidewalls as far as the crown, a belt that extends in the crown in the circumferential direction and is situated radially between the carcass reinforcement and the tread, said belt comprising a multilayer composite laminate comprising at least three superposed layers of reinforcers, said reinforcers being unidirectional within each layer and embedded in a thickness of rubber, respectively,
wherein, on a tread side, a first layer of rubber comprises a first row of reinforcers, said reinforcers being first reinforcers, which are oriented at an angle α of −5 to +5 degrees with respect to the circumferential direction, have an envelope diameter D1 of between 0.30 mm and 0.60 mm, and are made of a heat-shrinkable textile material;
wherein, in contact with the first layer of rubber and disposed beneath the first layer of rubber, a second layer of rubber comprises a second row of reinforcers, said reinforcers being second reinforcers, which are oriented at a given angle β, which is positive or negative, of between 10 and 30 degrees with respect to the circumferential direction and have a diameter D2 of between 0.20 mm and 0.50 mm;
wherein, in contact with the second layer of rubber and disposed beneath the second layer of rubber, a third layer of rubber comprises a third row of reinforcers, said reinforcers being third reinforcers, which are oriented at an angle γ, the opposite of the angle β, itself being between 10 and 30 degrees with respect to the circumferential direction and have a diameter D3 of between 0.20 mm and 0.50 mm;
wherein all or part of the first reinforcers made of heat-shrinkable textile material are multifilament fibres twisted individually on themselves according to a twist T greater than 100 turns per meter; and
wherein all or part of the second reinforcers, the third reinforcers or both the second and third reinforcers are composite reinforcers comprising steel monofilaments which are covered with a sheath of a thermoplastic material, the glass transition temperature Tg of which is higher than 20° C.

27. The tire according to claim 26, wherein the twist T is between 100 and 450 turns per meter.

28. The tire according to claim 27, wherein the twist T is between 120 and 350 turns per meter.

29. The tire according to claim 26, wherein a linear density of the multifilament fibres is between 50 and 250 tex.

30. The tire according to claim 29, wherein the linear density of the multifilament fibres is between 65 and 200 tex.

31. The tire according to claim 26, wherein D1 is between 0.35 and 0.55.

32. The tire according to claim 31, wherein D1 is between 0.40 and 0.50.

33. The tire according to claim 26, wherein a density d₁ of the first reinforcers in the first layer of rubber, measured in the axial direction, is between 90 and 150 threads/dm.

34. The tire according to claim 33, wherein the density d₁ is between 100 and 140 threads/dm.

35. The tire according to claim 26, wherein a thermal contraction CT of the first reinforcers, after 2 minutes at 185° C., is less than 7.5%.

36. The tire according to claim 35, wherein the CT is less than 7.0%.

37. The tire according to claim 36, wherein the CT is less than 6.0%.

38. The tire according to claim 26, wherein the heat-shrinkable textile material is a polyamide or a polyester.

39. The tire according to claim 26, wherein the monofilament fibres twisted individually on themselves represent the majority of the first reinforcers.

40. The tire according to claim 39, wherein the monofilament fibres twisted individually on themselves represent all of the first reinforcers.

41. The tire according to claim 26, wherein D2, D3 or both D2 and D3 are greater than 0.25 mm and less than 0.40 mm.

42. The tire according to claim 41, wherein D2, D3 or both D2 and D3 range from 0.28 to 0.35 mm.

43. The tire according to claim 26, wherein a minimum thickness Em of the thermoplastic sheath covering the steel monofilaments is between 5 and 150 μm.

44. The tire according to claim 43, wherein the minimum thickness Em is between 10 and 100 μm.

45. The tire according to claim 26, wherein the Tg is greater than 50° C.

46. The tire according to claim 45, wherein the Tg is greater than 70° C.

47. The tire according to claim 26, wherein the thermoplastic material is a polymer or a polymer composition.

48. The tire according to claim 47, wherein the polymer is a polyamide or a polyester.

49. The tire according to claim 26, wherein densities d₂ and d₃, respectively, of the second reinforcers and the third reinforcers, measured in the axial direction, are between 100 and 180 threads/dm.

50. The tire according to claim 49, wherein d₂ and d₃ are between 110 and 170 threads/dm.

51. The tire according to claim 50, wherein d₂ and d₃ are between 120 and 160 threads/dm.

52. The tire according to claim 26, wherein the steel is a carbon steel.

53. The tire according to claim 26, wherein the steel monofilaments sheathed with the thermoplastic sheath represent the majority of the second reinforcers.

54. The tire according to claim 53, wherein the steel monofilaments sheathed with the thermoplastic sheath represent all of the second reinforcers.

55. The tire according to claim 26, wherein the steel monofilaments sheathed with the thermoplastic sheath represent the majority of the third reinforcers.

56. The tire according to claim 55, wherein the steel monofilaments sheathed with the thermoplastic sheath represent all of the third reinforcers.

57. The tire according to claim 26, wherein a mean thickness Ez₁ of rubber separating a first reinforcer from a second reinforcer closest to it, measured in the radial direction, is less than 0.40 mm, when measured in a central part of the belt in the vulcanized state, on each side of a median plane over a total axial width of 10 cm.

58. The tire according to claim 57, wherein the mean thickness Ez₁ is between 0.20 and 0.40 mm.

59. The tire according to claim 26, wherein a mean thickness Ez₂ of rubber separating a second reinforcer from a third reinforcer closest to it, measured in the radial direction, is less than 0.60 mm, when measured in a central part of the belt in the vulcanized state, on each side of a median plane over a total axial width of 10 cm.

60. The tire according to claim 59, wherein the mean thickness E_{Z2} is between 0.35 and 0.60 mm.

61. The tire according to claim 26, wherein the following inequality is satisfied:
0.15<Ez₁/(Ez₁+D1+D2)<0.30,
where Ez₁ is a mean thickness of rubber separating a first reinforcer from a second reinforcer closest to it.

62. The tire according to claim 26, wherein the following inequality is satisfied:
0.20<Ez₂/(Ez₂+D2+D3)<0.50,
where Ez₂ is a mean thickness of rubber separating a second reinforcer from a third reinforcer closest to it.

63. The tire according to claim 26, wherein the following inequality is satisfied:
0.20<(Ez₁+Ez₂)/(Ez₁+Ez₂+D1+D2+D3)<0.40,
where Ez₁ is a mean thickness of rubber separating a first reinforcer from a second reinforcer closest to it, and Ez₂ is a mean thickness of rubber separating a second reinforcer from a third reinforcer closest to it.
